(19) United States
(12) Patent Application Publication
(10) Pub. No.: US 2025/0347139 A1
(43) Pub. Date: Nov. 13, 2025

(54) SYSTEM AND METHODS FOR CREMATION REMAINS

(71) Applicants: Frederick L. Berry, Reidsville, NC (US); Benjamin J. Berry, Reidsville, NC (US)

(72) Inventors: Frederick L. Berry, Reidsville, NC (US); Benjamin J. Berry, Reidsville, NC (US)

(21) Appl. No.: 19/203,925

(22) Filed: May 9, 2025

Related U.S. Application Data
(60) Provisional application No. 63/644,608, filed on May 9, 2024.

(51) Int. Cl. E04H 13/00; C04B 18/06; C04B 111/00

(52) U.S. Cl. CPC E04H 13/008; C04B 18/06; C04B 2111/00017

(57) ABSTRACT

Systems, methods, and memorial items including cremated remains are shown and described. The memorial item may be an environmentally safe item. A system for preserving cremated remains may include altering a pH of a slurry containing cremated remains.

### FIELD OF THE TECHNOLOGY

The present disclosure relates generally to methods for cremation remains, and more particularly to improved systems and methods for cremation remains, and further to preservation of cremation remains. Some examples of inventions of the present disclosure include a composition for preserving cremation remains, and an improved solidified item for suspending cremation remains in an environmentally friendly form.

### BACKGROUND

The passing of a loved one or family pet is impactful and emotionally challenging. The expense associated with burial often adds to the stress and can be cost prohibitive. Further, space limitations are becoming an element of concern as graveyards are filling and overcrowding becomes a reality. M any turn to cremation as a low cost, low impact alternative as compared to embalming, entombing, and cemetery residence.

While cremation practices are a very viable alternative to traditional burial practices, cremation is not without a distinct set of challenges. By way of example, storing or disseminating the cremated remains in a safe, reliable, sustainable and economical manner still presents challenges.

Therefore, Applicants desire systems and methods for processing, preserving, and/or storing of cremation remains resulting in an honorable, reliable, and economical alternative memorial option that accentuates the benefits that come with the choice of cremation, without the drawbacks presented by the traditional systems and methods.

### SUMMARY

In accordance with the present disclosure, processing of cremation remains into more environmentally friendly solidified forms are provided. This disclosure provides improved systems and methods for storage of cremated remains that are convenient, efficient, low cost, and safe for the handler and for the environment.

One embodiment of the present disclosure includes a memorial item including an interior including a composition of cremated ash, and an exterior surface having a protective layer.

In some examples, a composition for cremation remains includes a wet component, and a dry component including an amount of cremation remains. Other embodiments of the present disclosure include a method for forming a memorial item including: receiving cremation remains, processing the cremated remains to lower the pH, combining the cremated remains with a wet component, and/or preserving the cremated remains within the memorial item.

In other examples, a method, according to any of the embodiments or combination of embodiments herein, include methods for processing of cremation remains in an environmentally friendly way, without harsh chemicals, producing a solidified item containing the cremation remains that is also more environmentally friendly than the original cremation remains.

The above summary was intended to summarize certain embodiments of the present disclosure. Embodiments will be set forth in more detail in the figures and description of embodiments below. It will be apparent, however, that the description of embodiments is not intended to limit the present inventions, the scope of which should be properly determined by the appended claims.

### BRIEF DESCRIPTION OF THE DRAWINGS

Embodiments of the disclosure will be better understood by a reading of the Description of Embodiments along with a review of the drawings, in which:

FIG. 1 is a perspective view of a variable system for preservation of cremation remains according to an embodiment of the disclosure;

FIG. 2A is a perspective view of examples of a memorial item including cremation remains according to an alternative embodiment of the present disclosure;

FIG. 2B is a perspective view of another example of a memorial item including cremation remains according to an alternative embodiment of the disclosure;

FIG. 3 is a cross-sectional view of one example of a memorial item including cremation remains according to an embodiment of the disclosure;

FIG. 4 is a diagram of one example of initial processing of cremation remains in a method for preservation of cremation remains according to an embodiment of the disclosure;

FIG. 5 is a diagram of one example of mold preparation and composition processing for cremation remains in a method for preservation of cremation remains according to an embodiment of the disclosure; and

FIG. 6 is a diagram of one example of finish processing of cremation remains in a method for preservation of cremation remains according to an embodiment of the disclosure.

### DESCRIPTION OF EMBODIMENTS

The accompanying drawings, which are incorporated in and constitute a part of this disclosure, illustrate various embodiments of the present disclosure. The drawings may contain representations of various trademarks and copyrights owned by the Applicant. In addition, the drawings may contain other marks owned by third parties and are being used for illustrative purposes only. All rights to various trademarks and copyrights represented herein, except those belonging to their respective owners, are vested in and the property of the Applicant. The Applicant retains and reserves all rights in its trademarks and copyrights included herein, and grants permission to reproduce the material only in connection with reproduction of the granted patent and for no other purpose.

It will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified may be considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Certain examples and elements are described herein in detail in relation to one or more embodiments, it is to be understood that this disclosure is illustrative and exemplary of the present disclosure and are made merely to provide a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

In the following description, like reference characters designate like or corresponding parts throughout the several views. Also in the following description, it is to be understood that such terms as “forward,” “rearward,” “left,” “right,” “upwardly,” “downwardly,” and the like are words of convenience and are not to be construed as limiting terms.

The following detailed description refers to the accompanying drawings, photographs, pictures, and the like. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

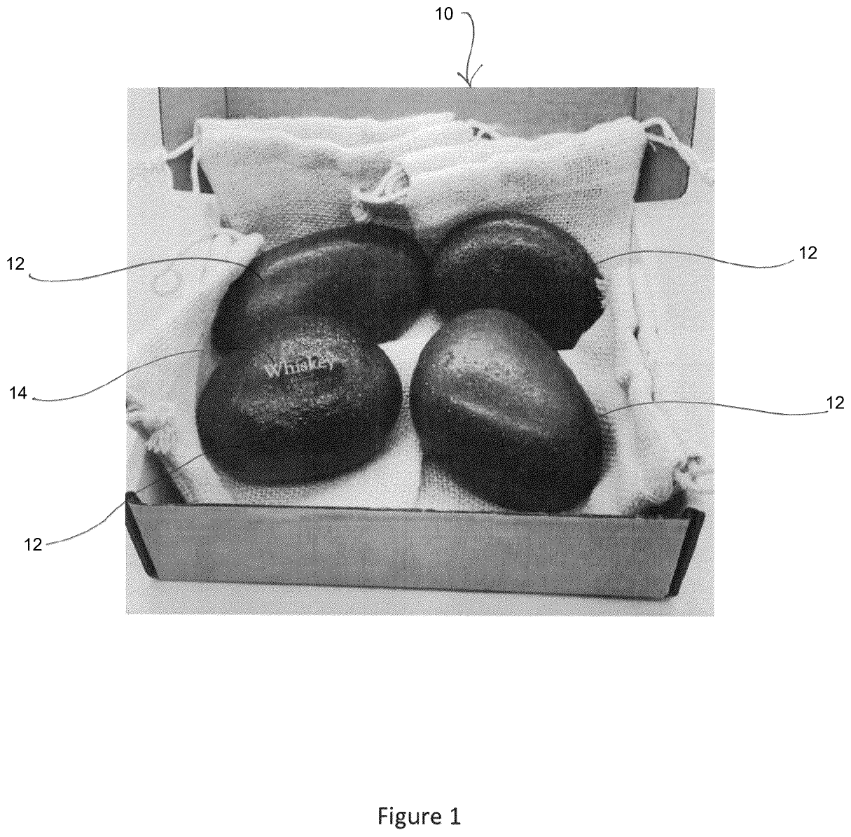

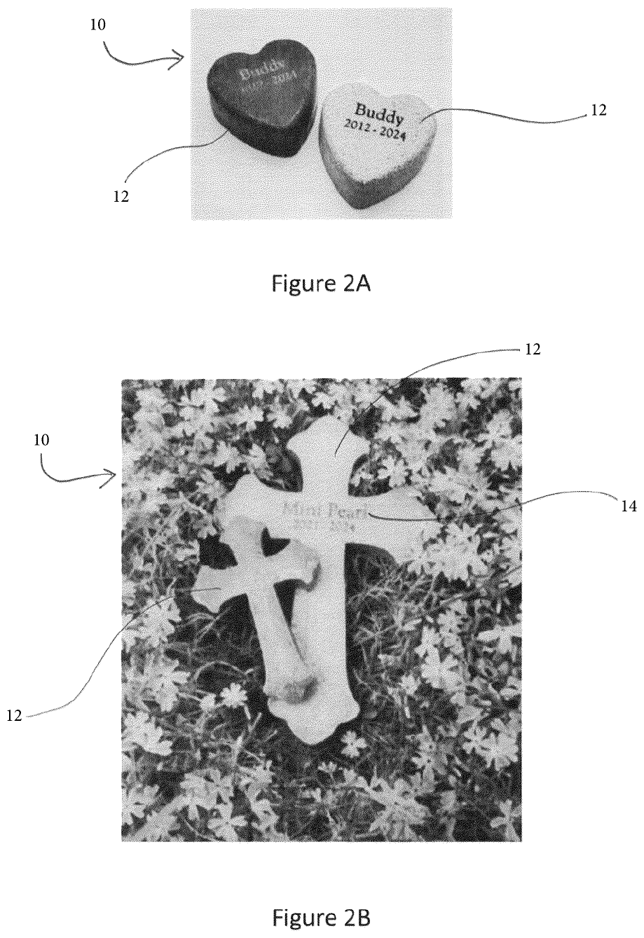

Referring now to the drawings in general, it will be understood that the illustrations are for the purpose of describing embodiments of the disclosure and are not intended to limit the disclosure or any invention thereto. FIG. 1 shows one embodiment of a variable relic system for preserving cremation remains 10. System for preserving cremation remains 10 may include one or more memorial item 12, shown in various embodiments. Memorial item 12 may take on any shape and include various sizes. By way of example, memorial item 12 may take on the shape of stones as seen in FIG. 1, hearts as seen in FIG. 2A, and/or a cross as seen in FIG. 2B. Memorial item 12 may include optional customization 14. By way of example, customization may include a name, a date, a message, etc. In one example of a variable cremation remains system, the example of cremation remains formed as a stone, the relic containing and preserving the cremation remains may take on variable shapes, oblong, non-symmetrical, round, oval triangular, etc.

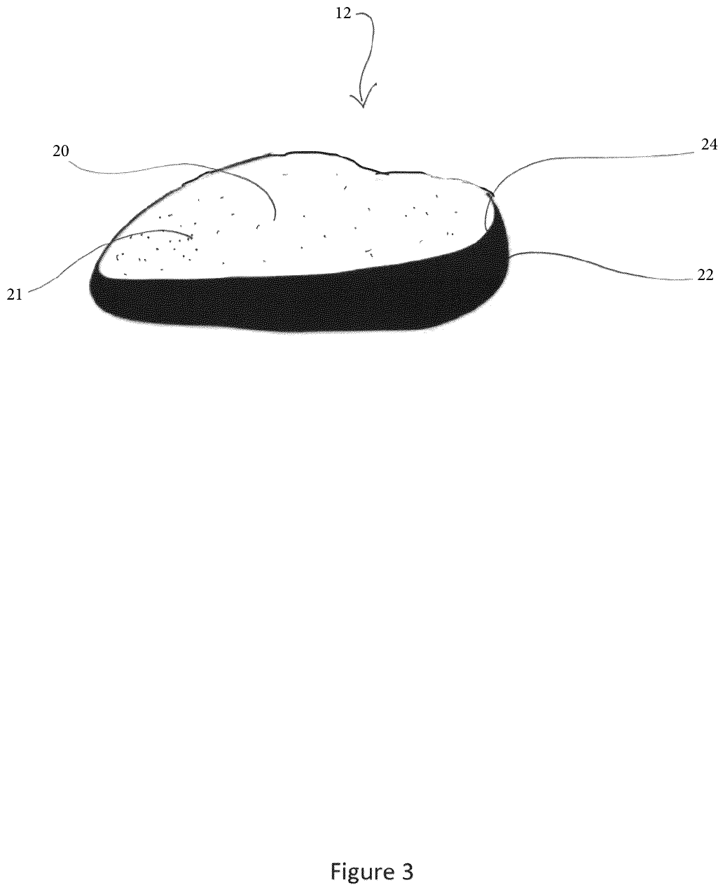

FIG. 3 is a cross-sectional view of a memorial item 12. Memorial items 12 may include an interior composition 20 including cremation remains 21, an outer surface 22, and/or an exterior protective layer 24.

A memorial item 12 may include a composition including a dry component and a wet component. The wet component may include: water, and a multi-range water reducing admixture, by way of example Sikament 475 by Sika. In some instances, where a particular coloration is desired, a color substance may be included. One example of a color substance according to the inventions of the present disclosure includes a Quikrete Liquid cement in color of choice. A dry component may include bone ash that has been powdered from the cremation remains and a portion of gypsum cement, by way of example Ultracal 30 Gypsum cement.

In one embodiment, a memorial item 12 may take on the shape of a natural stone (see FIG. 1) with the composition being adjusted to be molded and hardened to look like a natural stone. Certain examples of the memorial item 12 may be imitation stone and include small amounts or no natural occurring stone at all.

Systems 10 and methods 100 for preserving cremation remains in a memorial item 12 may include initial processing of a set of cremation remains, composition processing, mold preparation, and/or finishing.

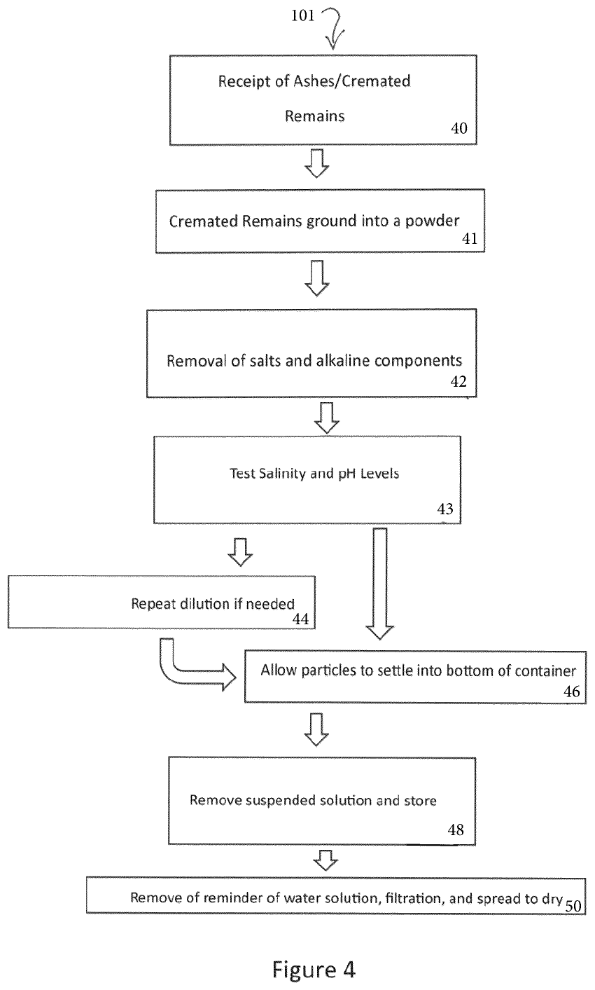

Embodiments of initial processing, referencing FIG. 4, may include the shipping of cremated remains/ashes 21 to a receiving facility. Labeling of the cremation remains are to be compliant with Publication 139,How to Package and Ship Cremated Remains. Cremated remains 21 arrive at facility and enter initial processing 40. The cremation ashes 21 arrive at facility and are inspected upon arrival to confirm identification information, for example, name, order details, and content of package received. Confirm of arrival of package with client may be sent and specifics of memorial item desired confirmed. Identification information is attached to a container, for example, a clean 5 gallon plastic bucket. The cremated remains 21 are ground into a fine ash powder 41. One way to accomplish griding of the cremated remains 21 is by way of use of nutribullet in small batches (for example ½ to 1 cup) to grind the cremated remains 21 into very fine powder before placing in the appropriately labeled bucket. The container, in this example, is then filled with warm water while stirring to allow excess salts and alkaline components to be released from bone (cremated remains) ash 42.

Some examples include testing the salinity and pH levels of a first dilution to determine how many rinses may be needed, by way of example, typically between 1 and 3 rinse cycles. M ore rinse cycles are considered within the scope of the inventions. The dilution may be repeated as needed 44. The larger bone ash particles are allowed to settle into the bottom of the bucket (by way of example, from 2-3 hours and in some examples at least 2 hours) 46. A pump system may be used to remove the solution suspended above the bone ash 48. This base solution may have extremely high salinity and the strong base solution may be held in exterior tanks for evaporation prior to proper disposal of salts. A rinse and pumping process may be repeated until solution above the settled bone ash has been lowered, for example to a pH of ˜7-8 (weak base), and, for example a salinity that may be below 100 ppm-leaving bone ash that will not leach salts and highly alkaline components into the environment. Cremated ash by itself can be too harsh to be placed in nature directly without detrimental effect. The salts and high pH may make for a hostile environment for plants and animals. By transforming the ashes using natural elements and coatings, the resulting memorial item 12 is much safer for the owner and for the environment if the cremated remains are reintroduced back into the soil or water. One embodiment of the present disclosure thus includes an environmentally friendly memorial item 12 with salts removed and/or lowered pH. In certain embodiments, at least 50% of the salt content may be removed, and in other examples at least 80%, and in other examples at least 90% of the salt may be removed.

In some examples, a pH may be treated to lower the pH of the cremated remains and/or a dilution for cremated remains. The cremated remains and/or dilution for cremated remains may be altered/treated to increase the acidity. In some instances, the resulting cremated remains mixture and the resulting memorial item 12 may include a pH lowered by at least one point (for example, from a pH scale reading of 12.0 to 11.0) and in some exemplary instances, by at least 2 points (for example, from a pH scale reading of 12.0 to 10.0). In particular embodiments, a treatment for cremated remains may reduce the pH (thus reducing how basic the mixture is and causing a neutralizing impact) of the cremated remains to a pH of 10.0 or less.

After lowered pH and/or salinity is achieved and final removal of a majority of water from the container, the remaining solution of water and fine particles of bone ash may be filtered, by way of example, using a large coffee filter. The remaining damp bone ash may be spread, for example, laid on a large metal tray, to dry, in some instances over night 50.

The following may depict an example of a method, of a plurality of methods, that may be performed by at least one of the aforementioned embodiments, or components thereof. Further, although the elements here may be disclosed in a particular order, it should be understood that the order is disclosed for illustrative purposes only. Elements may be combined, separated, reordered, and various intermediary stages may exist. Accordingly, it should be understood that the various assemblies, in various embodiments, may be performed/assembled in orders that differ from the ones disclosed below. Moreover, various stages may be added or removed without altering or departing from the fundamental scope of the depicted methods and systems disclosed herein.

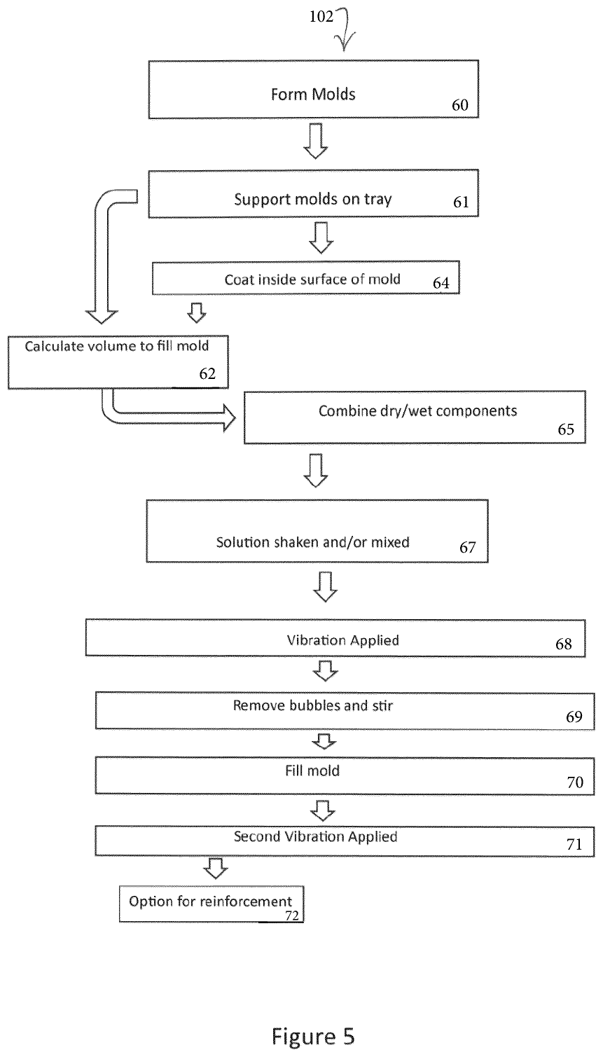

FIG. 5 illustrates an exemplary mold preparation method for forming preserving cremated remains into solid forms. M olds may be created 60 using natural stones coated, for example with latex rubber or silicone material. Forming a mold may take several days and creates a unique and reusable mold imitating a natural existing stone. M olds may be labeled with origin of the stone and the volume needed to fill mold. Selected molds may be placed on a tray and containers may be filled with sand to support the mold 60 and prevent warping when filled and during the curing process. The inside of selected molds may be coated with a layer to prevent sticking 64. In one embodiment, a castor oil and rubbing alcohol solution, may be sprayed into the mold and then spread by hand to insure all of the interior surface is coated. Approximate volume needed to fill selected molds is calculated prior to mixing of dry/wet components and noted 62.

A memorial item 12 may include a composition including a dry component and a wet component. The wet component may include: water, and a multi-range water reducing admixture, by way of example Sikament 475 by Sika. In some instances, where a particular coloration is desired, a color substance may be included. One example of a color substance according to the inventions of the present disclosure includes a Quikrete Liquid cement in color of choice. In one embodiment, a mixture of 1 gallon of water and 2 tablespoons of Sikament 475 admixture are mixed to form a wet component. If a color component is desired, an additional amount, for example, ⅓ cup Quikrete liquid cement color may be added. The mixture is well combined as color pigment has a tendency to settle at the bottom of the container.

The dry component may include bone ash that has been powdered from the cremation remains and a portion of gypsum cement, by way of example Ultracal 30 Gypsum cement. By way of example, one embodiment may include 3 parts bone ash: 1 part Ultracal 30 Gypsum Cement.

In some embodiments, the dry component and the wet component are combined 67. The total volume needed to fill all molds being filled is the best estimate for the amount of dry bone ash needed for filling molds. Ultracal 30, in one example, is calculated by 3:1 ratio for dry components. In one embodiment, dry bone ash is added to a mixing bowl followed by sifted Ultracal 30. Dry components are then blended thoroughly with, for example, an electric hand mixer. The liquid component may be added by sight while blending, for example with a hand mixer. The amount of liquid added may vary by individual's bone ash absorption of liquid components (by way of example around ½ of dry volume=approximate amount of liquid volume needed). The liquid component is added to the dry component and blended until the slurry resembles a loose pancake batter.

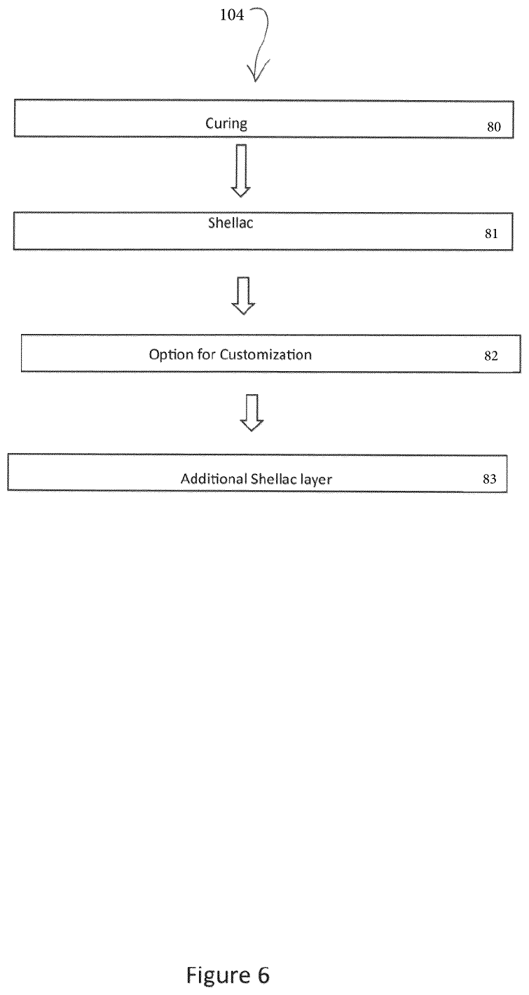

Examples include where the slurry in a container is placed on top of a vibrator and vibrated, in this example, at ½ power until bubbles rise to the surface of mixture 68. A spatula is then used to remove bubbles on top of the mixture, and then gently stirred again 69. In some instances, stratification may occur and remixing may be used to form a uniform mixture. The molds are filled with the wet and dry component mixture, in some examples, using a funnel 70. After the molds are filled, a second vibration of each filled mold, for example at ½ power for ˜30 seconds, may be used to prevent bubbles on the surface 71. Reinforcement may be applied, for example including a galvanized steel beam in a cross shaped item 72 and then the reinforcement may be covered with additional slurry to fill the mold. The items are allowed to harden and cure in the molds prior to removal, for example, for 72 hours (see FIG. 6, 104).

In certain examples curing has been realized as below for the wet/dry composition in the mold:

| | |
|---|---|
| Age | Strength percent |

| | | |
|---|---|---|
| 1 | day | 16% |
| 3 | days | 40% |
| 7 | days | 65% |
| 14 | days | 90% |
| 28 | days | 99% |

According to the examples above, 3 days after pouring, semi-cured material may be removed from molds and removal of large imperfections can be completed, for example by scraping of large bumps off surface as needed. Waiting, for example, around ten days after pour (7 days after unmolding), items, by example stones/crosses/hearts, may be sanded and smoothed. Imperfections and bubbles may still occur in surface of memorial items 12. Sediment from sanded stone may be combined with adhesive, for example, Sika Pro Select Concrete Bonding Adhesive, to create a very thin slurry that may be used to fill and smooth the imperfections in the surface of the item.

An outer layer may be applied after curing. By way of example, an item may be sprayed with several (4-5) thin layers of shellac. Shellac provides an environmentally friendly protective layer for the stones, enhances aesthetic quality, and improves engraving quality. The shellac layer may provide an outer layer that does not react negatively with the memorial item, including the cremation remains. Customization may be incorporated by adding a name or verse or engraving into the item. A final layer of shellac may then be added to seal the area of the engraving.

In some embodiments, inventions of the present invention may include an improved solidifying method and resulting solidified item for suspending cremation remains in an environmentally friendly form, according to any of the embodiments of the present disclosure.

Examples include a memorial item for preserving cremated remains that is at least 50% composition of cremated remains, in some examples, at least 60% and in some examples, at least 75%.

Regarding applicability of 35 U.S.C. § 112, 16, no claim element is intended to be read in accordance with this statutory provision unless the explicit phrase “means for” or “step for” is actually used in such claim element, whereupon this statutory provision is intended to apply in the interpretation of such claim element.

All rights, including copyrights herein, are vested in and the property of the Applicant.

The specification includes examples, the disclosure's scope is indicated by the following claims, and furthermore, while the specification has been described in language specific to structural features and/or methodological acts, the claims are not limited to the features or acts described above. Rather, the specific features and acts described above are disclosed as examples for embodiments of the disclosure. Insofar as the summary and description above and the accompanying drawing disclose any additional subject matter that is not within the scope of the claims below, the disclosures are not dedicated to the public and the right to file one or more applications to claims such additional disclosures is reserved.

Numerous characteristics and advantages have been set forth in the foregoing description, together with details of structure and function. M any of the novel features are pointed out in the appended claims. The disclosure, however, is illustrative only, and changes may be made in detail, especially in matters of shape, size, and arrangement of parts, within the principle of the disclosure, to the full extent indicated by the broad general meaning of the terms in which the general claims are expressed. It is further noted that, as used in this application, the singular forms “a,” “an,” and “the” include plural referents unless expressly and unequivocally limited to one referent.

What is claimed is:

1. A memorial item comprising:
an interior including a composition including,
an amount of cremated ash with at least a portion of salts and alkaline components removed, and
a carrier component for combining with the cremated ash,
an exterior surface having a protective layer encasing the interior.

2. The memorial item of claim 1 wherein the composition includes a wet component and a dry component.

3. The memorial item of claim 2 wherein the wet component includes a reduced pH.

4. The memorial item of claim 3 wherein the wet component includes a reduced salt content.

5. The memorial item of claim 1 wherein the memorial item is a cremated ash memorial item.

6. The memorial item of claim 5 wherein the salt content of the cremated ash is greater than the salt content of a wet component.

7. The memorial item of claim 5 wherein the pH of the cremated ash is lower than the pH of a wet component.

8. A cremation remains composition comprising:
a wet component,
a dry component including an amount of cremation remains,
wherein the wet component is combined with the dry component to form a slurry, and
wherein the slurry is hardened through curing.

9. The composition of claim 8 wherein at least 50 percent of the item is composed of cremation remains.

10. The composition of claim 8 including a cremation ash that has been ground into smaller particles from the cremation remains.

11. A method for forming a memorial item comprising:
receiving cremated remains,
processing the cremated remains to lower the pH,
combining the cremated remains with a wet component, and
preserving the cremated remains within the memorial item.

12. The method of claim 11 including grinding the cremated remains into a finer cremated ash powder.

13. The method of claim 12 including a wet component.

14. The method of claim 13 including a dry component.

15. The method of claim 14 including combining the wet component and the dry component into a slurry.

16. The method of claim 15 including increasing the pH of the wet slurry.

17. The method of claim 16 including reducing the salt content of the wet slurry.

18. The method of claim 17 including solidifying the wet slurry into a solidified item containing the cremation remains.

19. The method of claim 18 including applying a protective layer to the solidified item.

20. The method of claim 19 wherein the solidified item for suspending cremation is in an environmentally friendly form.
